(19) United States
(12) Patent Application Publication
(10) Pub. No.: US 2014/0325415 A1
(43) Pub. Date: Oct. 30, 2014

(54) INPUT DEVICE OF DISPLAY SYSTEM AND INPUT METHOD THEREOF

(71) Applicants: INTELLECTUAL DISCOVERY CO., LTD., Seoul (KR); ITVERS CO., LTD., Seoul (KR)

(72) Inventors: Youn Soo KIM, Seoul (KR); Hyekyeong KWON, Anyang-si (KR)

(73) Assignees: ITVERS CO., LTD., Seoul (KR); INTELLECTUAL DISCOVERY CO., LTD., Seoul (KR)

(21) Appl. No.: 14/264,469

(22) Filed: Apr. 29, 2014

(30) Foreign Application Priority Data
Apr. 30, 2013 (KR) 10-2013-0048607

(51) Int. Cl. G06F 3/0488; G06F 3/0486

(52) U.S. Cl. CPC G06F 3/0488; G06F 3/0486
USPC 715/769

(57) ABSTRACT

A display system input device includes a touchpad including a touch surface; a direction key divided into a plurality of sections on the touch surface, and a switch installed on a bottom surface of the touchpad. At least one among a drag signal, a tap signal, and a click signal is generated using at least one among the touchpad, the direction key, and the switch.

### CROSS-REFERENCE TO RELATED APPLICATION

This application claims priority to and the benefit of Korean Patent Application No. 10-2013-0048607, filed on Apr. 30, 2013, the disclosure of which is incorporated herein by reference in its entirety.

### BACKGROUND

1. Field of the Invention

The present invention relates to a display system input device capable of not only performing mouse pointing and scrolling but also inputting a signal for operating a direction key on a touchpad without causing a functional collision, thereby enabling users to more freely manipulate a display system such as a smart television (TV), and an input method thereof.

2. Discussion of Related Art

Various types of display systems, such as portable terminals, notebook computers, smartphones, smart pads, remote controllers for televisions (TVs), smart TVs, etc., have been used to provide information to users. An input device such as a touch panel, a touchpad, or an input key is installed in such a display system to input information on a screen of the display system.

Among such display systems, smart TVs or Android set-top boxes have user interface (UI) features that a direction key and a mouse cursor are used at substantially the same ratio. In the case of smart TVs, contents are displayed in the form of icons, and the sizes of icons displayed on a large-sized screen are greater than those of icons displayed on a screen of a personal computer (PC). Thus, icons may be more easily moved using a direction key in a horizontal or vertical direction than when a mouse cursor method of individually moving coordinates is used.

Thus, there are trends of installing a direction key and a mouse input device together in remote controllers and displaying an UI such that a cursor signal, a scroll signal, and a direction key movement signal are embodied in various ways to use various contents.

In the case of touchpads, various functions, such as a direction key, dragging and dropping, zooming in/out, etc., have been added in addition to a simple movement of a cursor and a scrolling function that have been generally used.

In general, in the existing touchpads, a touch region is divided into two parts: a cursor movement region and a scrolling region. However, a functional collision frequently occurs in a small-sized touchpad installed in a remote controller or the like when a touch region is divided into two parts. In particular, when a direction key is added to the touchpad, a functional collision is likely to occur frequently.

### SUMMARY OF THE INVENTION

The present invention is directed to a display system input device capable of performing functions, such as tapping, clicking, and dragging, in one touch region without any additional mode switch button, and an input method thereof.

The present invention is also directed to a display system input device capable of switching between various touch user interface (UI) functions in one touch region without any additional mode switch key, thereby increasing user convenience and improving a user input environment, and an input method thereof.

According to an aspect of the present invention, there is provided a display system input device including a touchpad including a touch surface, a direction key divided into a plurality of sections on the touch surface, and a switch installed on a bottom surface of the touchpad. At least one among a drag signal, a tap signal, and a click signal is generated using at least one among the touchpad, the direction key, and the switch.

The direction key may be divided into an upper section, a lower section, a left section, and a right section to move a pointer in up, down, left, and right directions.

The display system input device may further include a selection key divided from the direction key to generate a selection signal. When the selection key is selected, a selection key at coordinates of the pointer displayed on a display unit may be actuated.

When dragging is performed from a location on the touch surface to another location on the touch surface, the drag signal may be generated to move a cursor displayed on a display unit. When one of the upper, lower, left, and right sections of the direction key is clicked, the click signal may be generated to actuate the direction key. When a location on the touch surface is tapped, the tap signal may be generated to perform scrolling in up and down directions or left and right directions.

After the cursor is moved on the display unit by generating the drag signal, the clicking or the tapping may be continuously performed to actuate the direction key or perform scrolling.

After the direction key is actuated or scrolling is performed, dragging may be performed at least once to move the cursor on the display unit.

After the direction key is actuated or scrolling is performed, dragging may be performed by a predetermined length or more to move the cursor on the display unit.

Whether a set time period passes may be determined after the cursor is moved on the display unit. If the set time period passes, the direction key may be actuated when the clicking is performed. If the set time period does not pass, a selection key at coordinates of the cursor may be actuated when the clicking is performed.

After the direction key is actuated, whether a set time period passes may be determined. If the set period time passes, the scrolling may be performed when the tapping is performed. If the set period time does not pass, a selection key at coordinates of the cursor on the display unit may be actuated when the tapping is performed.

After the scrolling is performed, the cursor may be moved on the display unit when the dragging is performed, and the direction key may be actuated when the clicking is performed.

The switch may generate the click signal when an external downward force is applied to the touchpad at a reference level or more.

The display system input device may further include a restoration unit configured to elastically support the bottom surface of the touchpad in an up direction.

According to another aspect of the present invention, there is provided an input method performed by a display system input device, the input method including performing a cursor movement operation to move a cursor displayed on a display unit when dragging is performed from a location on a touch surface of a display system input device to another location on the touch surface, wherein the display system input device includes a touchpad including the touch surface, a direction key divided into a plurality of sections on the touch surface, and a switch installed on a bottom surface of the touchpad; performing a direction key actuation operation to actuate the direction key when one of the plurality of sections of the direction key on the touchpad is clicked; and performing a scroll actuation operation to perform scrolling in up and down directions or left and right directions when a location on the touch surface formed at a surface of the touchpad is tapped.

The input method may further include performing a selection key actuation operation to actuate a selection key at coordinates of a pointer displayed on the display unit when a selection key additionally formed on a surface of the touchpad is selected.

After a cursor movement operation is performed by performing the dragging, the clicking or the tapping may be continuously performed to perform the direction key actuation operation or the scroll actuation operation.

After the direction key actuation operation or the scroll actuation operation is performed, touch-dragging may be performed at least once to perform the cursor movement operation.

After the direction key actuation operation or the scroll actuation operation is performed, the dragging may be performed by a predetermined length or more to perform the cursor movement operation.

The input method may further include performing a set time period determination operation to determine whether a set time period passes after the cursor movement operation is performed. If it is determined in the set time period determination operation that the set time period passes, the direction key actuation operation may be performed when the clicking is performed. If it is determined in the set time period determination operation that the set time period does not pass, a selection key actuation operation may be performed to actuate a selection key at coordinates of the cursor displayed on the display unit when the clicking is performed.

After the direction key actuation operation is performed, a set time period determination operation may be performed to determine whether a set time period passes. If it is determined in the set time period determination operation that the set time period passes, the scroll actuation operation may be performed when the tapping is performed. If it is determined in the set time period determination operation that the set time period does not pass, a selection key actuation operation may be performed to actuate a selection key at coordinates of a pointer displayed on the display unit when the tapping is performed.

After the scroll actuation operation is performed, the cursor movement operation may be performed when the dragging is performed, and the direction key actuation operation may be performed when the clicking is performed.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a state diagram of a display system input device according to one exemplary embodiment of the present invention;

FIG. 2 is a state diagram of a display system input device according to another exemplary embodiment of the present invention;

FIG. 3 is a cross-sectional view of an internal structure of a touchpad illustrated in FIG. 1 or 2;

FIG. 4 is a flowchart of a display system input method according to an exemplary embodiment of the present invention; and

FIGS. 5 to 7 are detailed flowcharts of examples of the display system input method of FIG. 4.

### DETAILED DESCRIPTION OF EXEMPLARY EMBODIMENTS

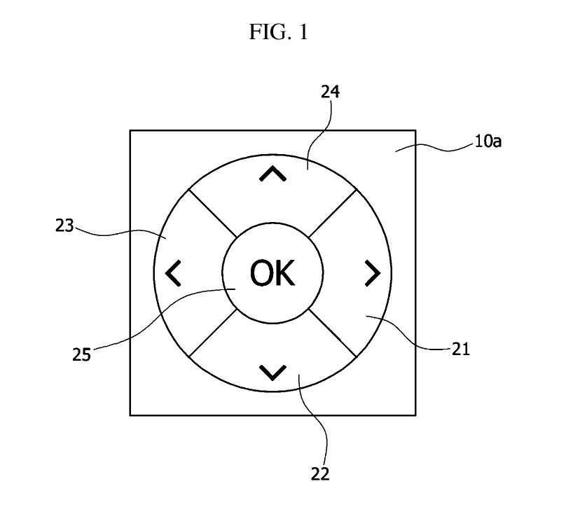

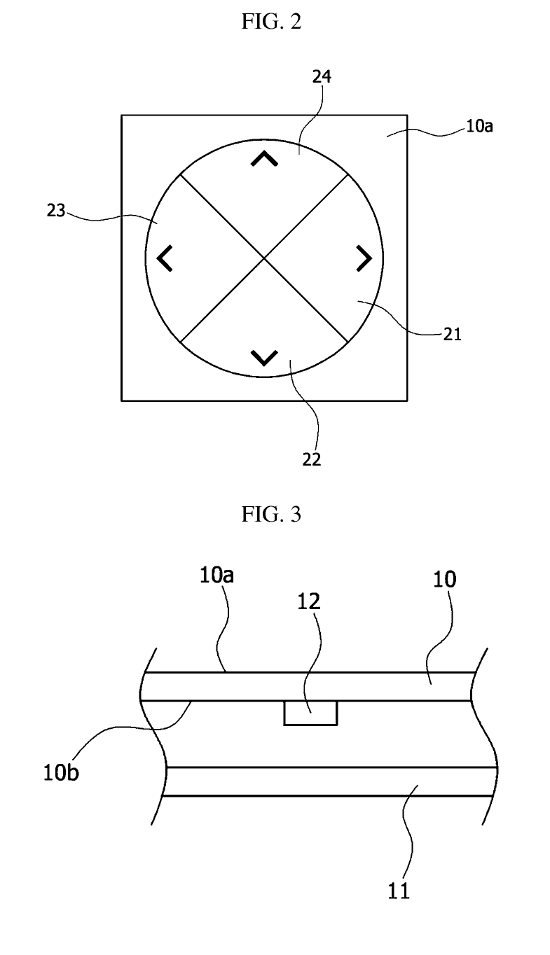

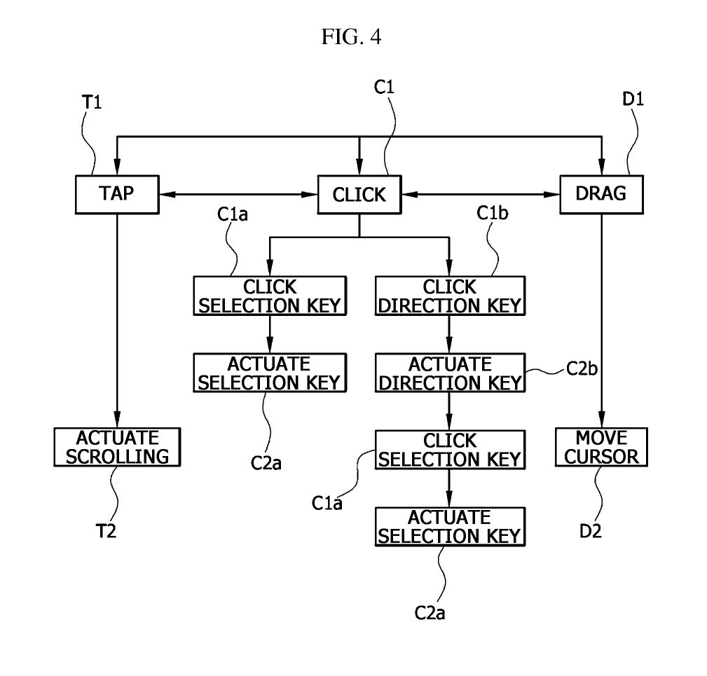

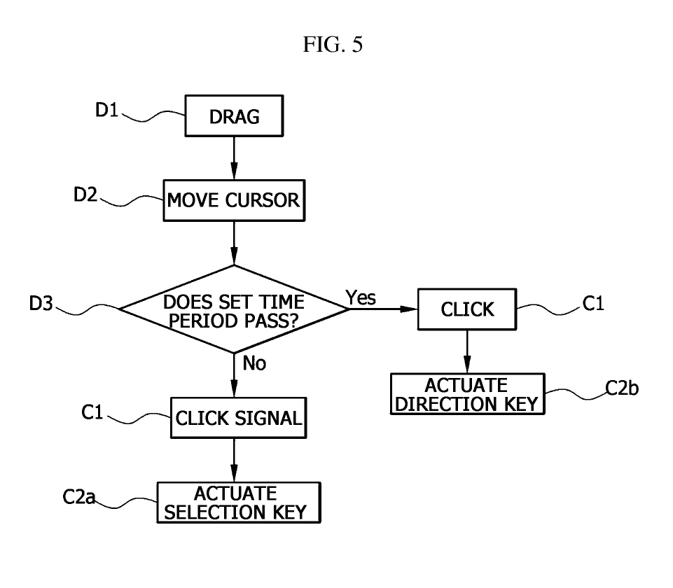

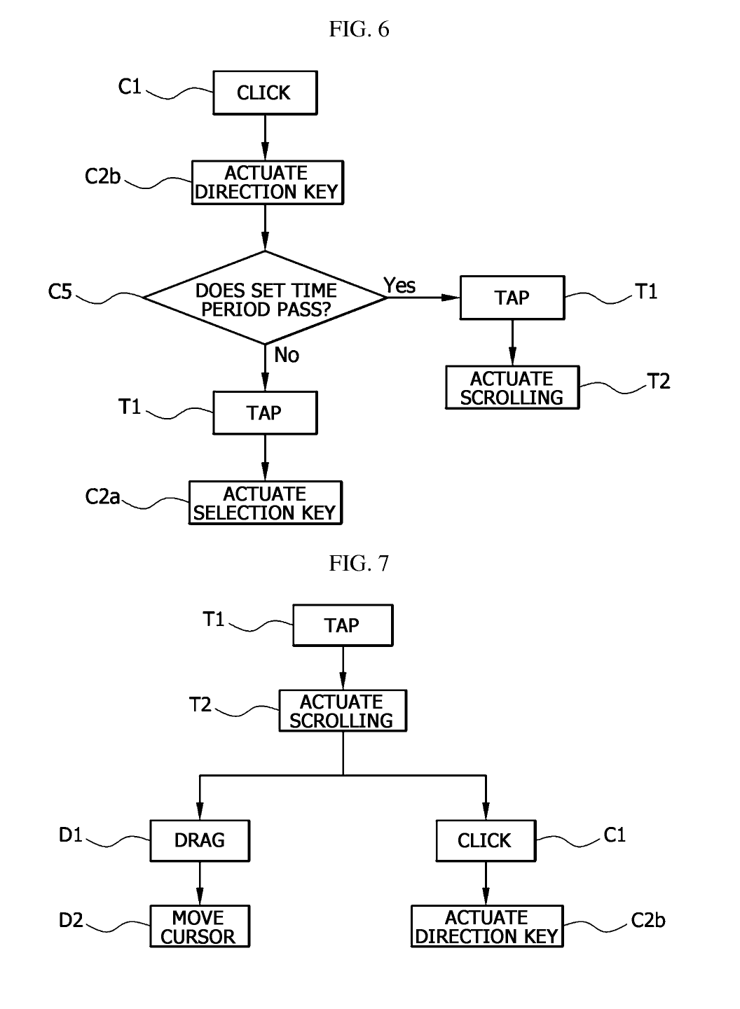

FIG. 1 is a state diagram of a display system input device according to one exemplary embodiment of the present invention. FIG. 2 is a state diagram of a display system input device according to another exemplary embodiment of the present invention. FIG. 3 is a cross-sectional view of an internal structure of a touchpad illustrated in FIG. 1 or 2. FIG. 4 is a flowchart of a display system input method according to an exemplary embodiment of the present invention. FIGS. 5 to 7 are detailed flowcharts of examples of the display system input method of FIG. 4.

As illustrated in FIGS. 1 to 3, the display system input device according to an exemplary embodiment of the present invention includes a touchpad 10 having a touch surface 10a that is coupled to a top surface of a housing 11 including an accommodating unit thereof and on which dragging is performed, a switch 12 installed on a bottom surface 10b of the touchpad 10 and configured to come in contact with a bottom surface of the housing 11 and generate an ‘on’ signal when an external downward force is applied to the touchpad 10 at a reference level or more, and a restoration unit (not shown) installed between the touchpad 10 and the housing 11 to elastically support the bottom surface 10b of the touchpad 10.

The touch surface 10a is divided into a plurality of sections (preferably, four sections) to correspond to direction keys 21, 22, 23, and 24. In this case, the direction keys 21 to 24 may be set to move a cursor displayed on a screen in up, down, left, and right directions or to increase a channel number or volume in the up, down, left, and right directions.

A display system input device according to an embodiment of the present invention as described above may be used for various types of display systems that provide information to users, such as portable terminals, notebook computers, smartphones, smart pads, smart set-top boxes, remote controllers for televisions (TVs), and smart TVs. In the present disclosure, the present invention is described with respect to a case in which the display system input device is used for smart TVs.

Also, a selection key 25 may be additionally installed at the center of the direction keys 21 to 24 on the touch surface 10a as illustrated in FIG. 1. The selection key 25 is a button for actuating a selection key at the coordinates of a cursor displayed on a display unit.

When the switch 12 is installed on the bottom surface 10b of the touchpad 10 to sense clicking, a click signal and a tap signal are selectively generated according to an ‘on’/‘off’ signal output from the switch 12. In this case, the ‘clicking’ means actuation of an execution key when the switch 12 is ‘on’ by applying an external force to the touchpad 10 in a vertical direction, and the ‘tapping’ generally means an input method performed by tapping a touch surface of a touchpad that is generally installed in a notebook computer by lightly touching the touch surface once or twice.

In an input method according to an exemplary embodiment of the present invention performed using the display system input device configured as described above, when dragging D1 is performed to another location on the touch surface 10a of the touchpad 10 while contacting a location on the touch surface 10a, a cursor movement operation D2 is performed to actuate movement of a cursor displayed on a display unit as illustrated in FIGS. 4 to 7.

Referring to FIG. 4, when clicking C1 is performed to apply an external downward force to the direction key 21, 22, 23, or 24 on the touchpad 10 at a reference level or more, a direction key actuating operation C2b is performed to actuate the direction key 21, 22, 23, or 24 to generate an actuation signal.

When tapping T1 is performed to apply pressure to a predetermined location on the touch surface 10a of the touchpad 10 such that an external downward force is applied to the predetermined location on the touch surface 10a at less than the reference level, a scroll actuation operation T2 is performed to perform scrolling in the up/down direction or the left/right direction.

When the selection key 25 of FIG. 1 is clicked while the dragging D1 is performed to move the cursor, a selection key actuation operation C2a may be performed to actuate a selection key at the coordinates of the cursor regardless of the location of a pointer of a current direction key.

When the selection key 25 on the center of the four direction keys 21 to 24 is clicked while a direction key actuation signal is produced by clicking a location on which the direction keys 21 to 24, which form a peripheral portion of the touch surface 10a, are displayed, a selection key at a pointer at which the direction keys 21 to 24 are located is first actuated regardless of a location pointed by the cursor.

When cursor pointing is performed by performing the dragging D1, clicking is performed by clicking the peripheral portion, and the tapping T1 is performed not to turn on the switch 12 in four directions with respect to the selection key 25 on the center of these direction keys, scrolling is performed in the up/down direction or the left/right direction.

When mouse pointing is performed by performing the dragging D1, the direction key 21, 22, 23, or 24 is used, and scrolling is performed at the same time without switching between modes, a collision may occur between actuation signals due to a malfunction. In this case, when the clicking C1 or the tapping T1 is performed while the cursor movement operation D2 is performed by performing the dragging D1, an input signal indicating that an input gesture continuously occurs on the same location twice may be generated to minimize errors.

On the contrary, in order to perform the dragging D1 while the clicking C1 is performed to click a direction key to perform the direction key actuating operation C2b or the tapping T1 is performed, the dragging D1 may be performed only when the dragging D1 is performed twice or is performed by a predetermined length or more, thereby reducing malfunctions.

Next, an input method performed on the touchpad 10 on which only the four direction keys 21 to 24 are formed without the selection key 25 will be described in detail below.

As illustrated in FIG. 5, according to an embodiment of the present invention, a cursor movement operation D2 is performed by performing dragging D1 and then a set time period determination operation D3 is performed to determine whether a set time period passes or not. In this case, if the set time period passes, a direction key actuation operation C2b is performed when clicking C1 is performed. If the set time period does not pass, a selection key actuation operation C2a is performed to actuate a selection key at the coordinates of a cursor displayed on a display unit when the clicking C1 is performed. That is, the selection key at the coordinates of the cursor is actuated when a random location is clicked within the set time period during actuation of the cursor by performing dragging, and a direction key is actuated when clicking is performed without additionally actuating the cursor and the predetermined set time period passes after the cursor is actuated. Although not shown, the direction key actuation operation C2b and the selection key actuation operation C2a may be switched to each other according to whether the predetermined set time period passes.

As illustrated in FIG. 6, after a direction key actuation operation C2b is performed by performing clicking C1, a set time period determination operation D3 is performed to determine whether a set time period passes or not. In this case, a scroll actuation operation T2 is performed when tapping T1 is performed after the set time period, and a selection key actuation operation C2a is performed to actuate a selection key at the coordinates of a cursor displayed on a display unit when the tapping T1 is performed within the set time period. That is, scrolling is performed when tapping is performed within the set time period while a direction key is actuated by clicking the direction key, and a selection key on a pointer on which a direction key is located is actuated when the set time period passes after the direction key is actuated and tapping is performed without additionally actuating a direction key. Although not shown, the selection key actuation operation C2a and the scroll actuation operation T2 may be set to be switched to each other when the set time period passes.

As illustrated in FIG. 7, after a scroll actuation operation T2 is performed by performing tapping T1, a cursor movement operation D2 may be performed when dragging D1 is performed and a direction key actuation operation C2b may be performed when clicking C1 is performed.

As described above, the advantages of the present invention have already been verified by conducting an internal touchpad sample test. When a tapping function that has been generally used on touchpads including a click button among the existing touchpad products is replaced with a click button, it is possible to more effectively switch to a tapping region on the touchpad, thereby maximizing device efficiency. Also, since pointing, scrolling, and direction keys may be used simultaneously, a plurality of different input devices need not alternately used, thereby enabling a user to intuitively and conveniently manipulate a display system input device. Also, since chips to be installed in a module can be integrated as one chip, the display system input device operates with a low current and thus can be used for a long time, thereby reducing power consumption, whereas power consumption is high in other products since different chips are installed in a plurality of input modules.

In a display system input device according to an embodiment of the present invention as described above, it is possible to move a cursor, actuate a direction key, and perform scrolling on a touchpad without causing a functional collision to occur, thereby increasing user convenience.

Also, according to an embodiment of the present invention, it is possible to switch between various touch UI functions within one touch region without an additional mode switch key, thereby increasing user convenience and improving a user input environment.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A display system input device comprising:
a touchpad including a touch surface;
a direction key divided into a plurality of sections on the touch surface; and
a switch installed on a bottom surface of the touchpad,
wherein at least one among a drag signal, a tap signal, and a click signal is generated using at least one among the touchpad, the direction key, and the switch.

2. The display system input device of claim 1, wherein the direction key is divided into an upper section, a lower section, a left section, and a right section to move a pointer in up, down, left, and right directions.

3. The display system input device of claim 1, further comprising a selection key divided from the direction key to generate a selection signal,
wherein, when the selection key is selected, a selection key at coordinates of the pointer displayed on a display unit is actuated.

4. The display system input device of claim 1, wherein, when dragging is performed from a location on the touch surface to another location on the touch surface, the drag signal is generated to move a cursor displayed on a display unit,
when one of the upper, lower, left, and right sections of the direction key is clicked, the click signal is generated to actuate the direction key, and
when a location on the touch surface is tapped, the tap signal is generated to perform scrolling in up and down directions or left and right directions.

5. The display system input device of claim 4, wherein, after the cursor is moved on the display unit by generating the drag signal, the clicking or the tapping is continuously performed to actuate the direction key or perform scrolling.

6. The display system input device of claim 4, wherein, after the direction key is actuated or scrolling is performed, dragging is performed at least once to move the cursor on the display unit.

7. The display system input device of claim 4, wherein, after the direction key is actuated or scrolling is performed, dragging is performed by a predetermined length or more to move the cursor on the display unit.

8. The display system input device of claim 4, wherein whether a set time period passes is determined after the cursor is moved on the display unit,
wherein if the set time period passes, the direction key is actuated when the clicking is performed, and
if the set time period does not pass, a selection key at coordinates of the cursor is actuated when the clicking is performed.

9. The display system input device of claim 4, wherein, after the direction key is actuated, whether a set time period passes is determined,
wherein if the set period time passes, the scrolling is performed when the tapping is performed, and
if the set period time does not pass, a selection key at coordinates of the cursor on the display unit is actuated when the tapping is performed.

10. The display system input device of claim 4, wherein, after the scrolling is performed, the cursor is moved on the display unit when the dragging is performed, and the direction key is actuated when the clicking is performed.

11. The display system input device of claim 1, wherein the switch generates the click signal when an external downward force is applied to the touchpad at a reference level or more.

12. The display system input device of claim 1, further comprising a restoration unit configured to elastically support the bottom surface of the touchpad in an up direction.

13. An input method performed by a display system input device, comprising:
performing a cursor movement operation to move a cursor displayed on a display unit when dragging is performed from a location on a touch surface of a display system input device to another location on the touch surface, wherein the display system input device includes a touchpad including the touch surface, a direction key divided into a plurality of sections on the touch surface, and a switch installed on a bottom surface of the touchpad;
performing a direction key actuation operation to actuate the direction key when one of the plurality of sections of the direction key on the touchpad is clicked; and
performing a scroll actuation operation to perform scrolling in up and down directions or left and right directions when a location on the touch surface of the touchpad is tapped.

14. The input method of claim 13, further comprising performing a selection key actuation operation to actuate a selection key at coordinates of a pointer displayed on the display unit when a selection key additionally formed on the touch surface of the touchpad is selected.

15. The input method of claim 13, wherein, after a cursor movement operation is performed by performing the dragging, the clicking or the tapping is continuously performed to perform the direction key actuation operation or the scroll actuation operation.

16. The input method of claim 13, wherein, after the direction key actuation operation or the scroll actuation operation is performed, touch-dragging is performed at least once to perform the cursor movement operation.

17. The input method of claim 13, wherein, after the direction key actuation operation or the scroll actuation operation is performed, the dragging is performed by a predetermined length or more to perform the cursor movement operation.

18. The input method of claim 13, further comprising performing a set time period determination operation to determine whether a set time period passes, after the cursor movement operation is performed,
wherein if it is determined in the set time period determination operation that the set time period passes, the direction key actuation operation is performed when the clicking is performed, and
if it is determined in the set time period determination operation that the set time period does not pass, a selection key actuation operation is performed to actuate a selection key at coordinates of the cursor displayed on the display unit when the clicking is performed.

19. The input method of claim 13, wherein, after the direction key actuation operation is performed, a set time period determination operation is performed to determine whether a set time period passes,
wherein if it is determined in the set time period determination operation that the set time period passes, the scroll actuation operation is performed when the tapping is performed, and
if it is determined in the set time period determination operation that the set time period does not pass, a selection key actuation operation is performed to actuate a selection key at coordinates of a pointer displayed on the display unit when the tapping is performed.

20. The input method of claim 13, wherein, after the scroll actuation operation is performed, the cursor movement operation is performed when the dragging is performed, and the direction key actuation operation is performed when the clicking is performed.
